(19) United States
(12) Patent Application Publication
(10) Pub. No.: US 2024/0347918 A1
(43) Pub. Date: Oct. 17, 2024

(54) RECONFIGURABLE INTELLIGENT SURFACE ANTENNA FOR RADIO FREQUENCY SIGNAL MITIGATION

(71) Applicant: Drexel University, Philadelphia, PA (US)

(72) Inventors: Kyei Anim, Philadelphia, PA (US); Md Abu Saleh Tajin, Millbourne, PA (US); Kapil R Dandekar, Philadelphia, PA (US)

(21) Appl. No.: 18/637,741

(22) Filed: Apr. 17, 2024

Related U.S. Application Data
(63) Continuation of application No. 63/496,511, filed on Apr. 17, 2023.

(51) Int. Cl. H01Q 9/27; H01Q 5/25; H04B 7/04

(52) U.S. Cl. CPC H01Q 9/27; H01Q 5/25; H04B 7/04013

(57) ABSTRACT

Reconfigurable intelligent surfaces (RISs) are an emerging transmission technology to aid wireless communication. However, the potential of using RIS to mitigate directed energy weapons (DEW) is not widely recognized. Described herein are RIS (based on spiral antenna elements) to aid the mitigation of high-energy radio-frequency (RF) sources applied to a DEW. For example, integrating a broadband circularly-polarized antenna system with RIS technology can successfully mitigate DEW attacks across a wide range of frequencies regardless of how radio waves are polarized. A spiral antenna is simulated that operates between 1.3 GHz and 7 GHz with a 3-dB axial ratio bandwidth (ARBW) covering 2 GHz-7 GHz. Full-wave simulation results show the potential promising application of RIS for the mitigation of DEW attacks.

### CROSS REFERENCE TO RELATED APPLICATIONS

The present application claims priority to and the benefit of U.S. Patent Application No. 63/496,511, “Reconfigurable Intelligent Surface Antenna for Radio Frequency Signal Mitigation” (filed Apr. 17, 2023), the entirety of which application is incorporated herein by reference for any and all purposes.

### GOVERNMENT RIGHTS

This invention was made with government support under NSF 1816387 awarded by the National Science Foundation. The government has certain rights in the invention.

### TECHNICAL FIELD

The present disclosure relates to the field of reconfigurable intelligent surfaces (RISs).

### BACKGROUND

A reconfigurable intelligent surface (RIS) generally can be thought of as an electronically configurable radio frequency (RF) “lens” or “mirror” to let the signal get through or reflect it via passive beamforming. This allows for improving a legitimate link between radio nodes or impair RF interference. By deploying a large array of passive electronically tunable reflecting elements in a given environment, the electromagnetic propagation channel (generally regarded as an immutable black box) can be dynamically controlled, which allows for beamforming functionality not only by the radio endpoints but also in the wireless environment.

Despite their enormous potential benefits, the possibility of using RIS to mitigate Directed Energy Weapons (DEW) and their effects is not widely recognized. High-power RF sources applied to a directed energy weapon can cause permanent damage (e.g., heat stroke, cognitive impairment, and microwave auditory effect) by releasing concentrated energy in a specific direction

### SUMMARY

RIS devices to assist in the mitigation of DEW attacks are described herein. RISs are composed of an extensive array of passive antennas with electronically tunable properties for beamforming transmissions. Thus, the integration of a wideband circularly-polarized antenna system with RIS technology can potentially be used to alleviate DEW attacks across a wide range of frequencies regardless of the polarization of electromagnetic waves. A simulated RIS based on a spiral antenna unit cell that achieves an impedance bandwidth of 135% (1.3-7 GHZ) and a 3-dB axial ratio bandwidth (ARBW) of 100% (2-7 GHz). Thus, at 3.7 GHZ, the proposed RIS provides a 16 dB decrease in received power between the “ON” and “OFF” states, which demonstrates the potential promising application of RIS for DEW mitigation.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

The figures for this disclosure are provided in Appendix A, which is incorporated herein in its entirety for any and all purposes.

FIG. 1 depicts an Ansys SpaceClaim model of city buildings imported into HFSS. RIS is positioned between an RF source and a receiver (human target).

FIG. 2 depicts HFSS model of a spiral antenna.

FIG. 3 depicts simulated results of the spiral antenna: a) |S₁₁|. b) axial ratio (AR).

FIG. 4 depicts simulated RF received power v. frequency plot.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4. Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

### Design and Simulation

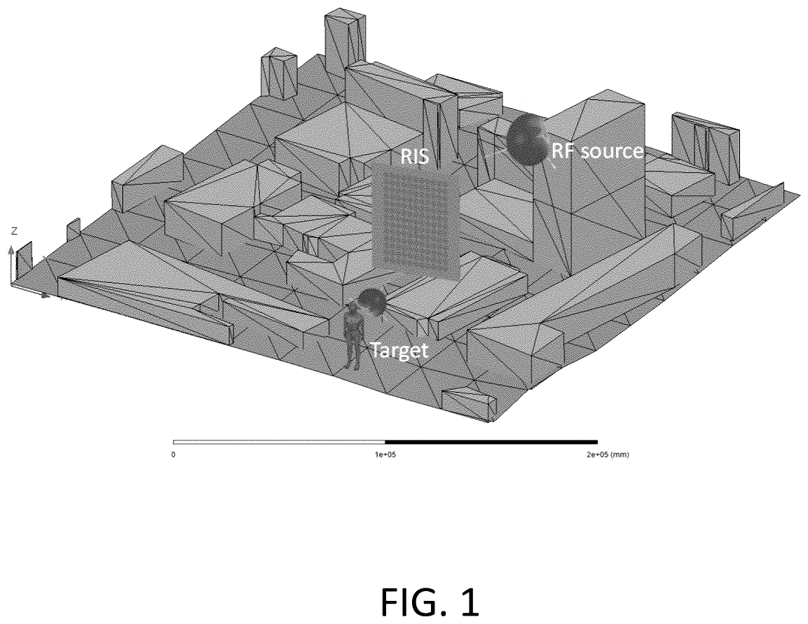

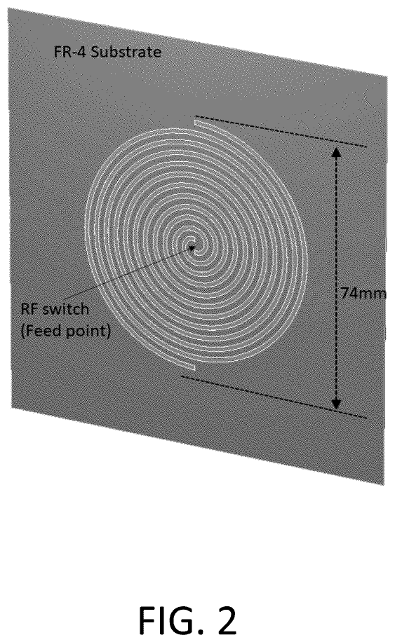

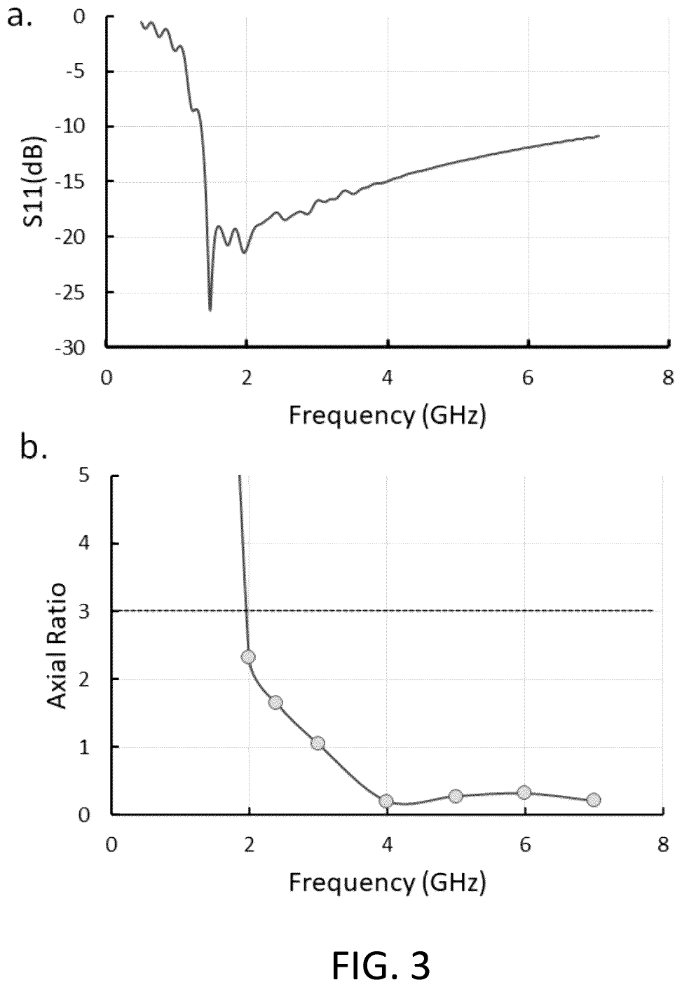

A preliminary study that leverages a reconfigurable intelligent surface (RIS) to mitigate directed energy weapons is demonstrated in FIG. 1. To validate this concept, the RIS structure (inspired by the electromagnetic designs in [2, 4]) was positioned between a transmitter (an RF source) and a receiver (a human target) in a 3D electromagnetic simulation software Ansys HFSS, as illustrated in FIG. 1. Both the transmitter and receiver antennas are modeled as half-wave dipoles operating at 2.4 GHz. However, the RIS is simulated with 11×13 spiral antenna elements (FIG. 2) placed in a periodic arrangement on an FR-4 substrate. The reflection coefficients (S11) and axial ratio (AR) of the spiral antenna were plotted in FIG. 3. The simulated results show that the spiral antenna operates from 1.3 to 7 GHz with a 3-dB axial ratio bandwidth (ARBW) of about 100% (2 GHZ-7 GHZ). Thus, the proposed RIS has the potential to work across a wide range of frequencies independent of the polarization of the transmitted EM waves. It should be noted that each spiral antenna is equipped with an RF switch (modeled by a lumped port in simulation) to set the “on” and “off”' state of each RIS element. The overall size of the simulated RIS is 1.2 m×1.2 m.

### Results and Discussion

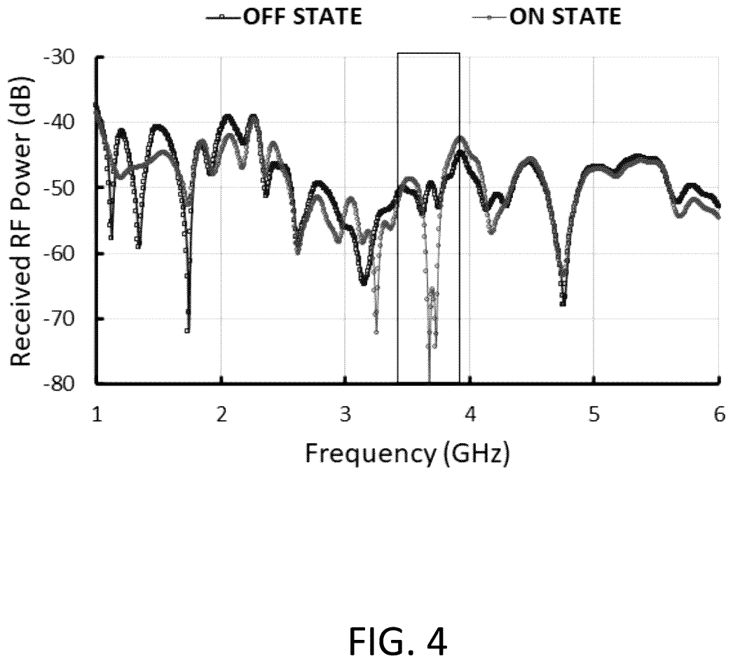

The simulated results in FIG. 4 show that the received RF power (S21) at the target location decreases significantly during the RIS “on” state (when all elements are turned on) compared with the “off” state around 3.7 GHZ. When all switches are turned on, the elements become active and efficiently interact with the impinging RF signals setting up the RIS to work as a mirror to reflect any RF radiation away from the target. On the contrary, during the RIS “off” state, the elements weakly interact with the RF signals as the arm of the spiral antenna itself is relatively small. Thus, the RIS partially assumes microwave transparency and allows a significant fraction of the incoming RF energy to pass through it, which increases the received power (S21), as observed in FIG. 4. It should be noted that the influence of the RIS on the incoming signal should ideally be maximized at the frequency of transmission, which in this case is 2.4 GHz. However, as observed in FIG. 4, the RIS maximum impact occurs at 3.7 GHz during the ‘ON” state. This frequency shift can be resolved by increasing the separation distance between the RIS and the dipole antennas in simulation, but it can cause an out-of-memory error in HFSS. Thus, around 3.7 GHZ, the proposed RIS provides about a 16 dB decrease in received power between the “ON” and “OFF” states. These initial results demonstrate the potential promising application of RIS for DEW mitigation.

What is claimed:

1. A reconfigurable intelligent surface (RIS) antenna, comprising:
a plurality of radio frequency (RF) receiver elements electrically coupled to each other;
a RF switch electrically coupled to at least one of the plurality of RF receiver elements and configured to convert the plurality of RF receiver elements between an on mode and an off mode; and
a substrate coupled to each of the plurality of RF receiver elements,
wherein the plurality of RF receiver elements are configured to at least partially block a RF signal from passing through the RIS antenna when the plurality of RF receiver elements are in the on mode, and
wherein the plurality of RF receiver elements are configured to permit at least partial passage of the RF signal through the RIS antenna when the plurality of RF receiver elements are in the off mode.

2. The RIS antenna of claim 1, wherein the plurality of RF receiver elements form a spiral antenna.

3. The RIS antenna of claim 1, wherein the RIS antenna comprises a wideband antenna.

4. A RIS antenna array, comprising a plurality of the RIS antennas of claim 1.

5. The RIS antenna array of claim 4, wherein each of the plurality of the RIS antennas is disposed along a plane formed by the substrate for each of the plurality of RIS antennas.
